(19) United States
(12) Patent Application Publication
(10) Pub. No.: US 2023/0271094 A1
(43) Pub. Date: Aug. 31, 2023

(54) Amusement System, Vehicle And Method

(71) Applicants: Charles Bell, Wilmington, DE (US); Clifford Black, JR., Wilmington, DE (US)

(72) Inventors: Charles Bell, Wilmington, DE (US); Clifford Black, JR., Wilmington, DE (US)

(21) Appl. No.: 17/652,488

(22) Filed: Feb. 25, 2022

(51) Int. Cl. A63G 31/02

(52) U.S. Cl. CPC A63G 31/02; G01S 19/51

(57) ABSTRACT

The present invention relates to system, vehicle and method for providing an amusement activity. According to one embodiment, it is provided an amusement vehicle adapted for carrying a passenger, the vehicle comprising of a wireless signal receiver, a trigger mechanism and amusement means, a wireless signal transmitter capable of transmitting a signal to said amusement vehicle, the signal defining a trigger mechanism, an amusement scene and a proximity context, wherein the wireless signal transmitter transmits a signal to a vehicle in an amusement path, the vehicle receives the signal comprising a trigger mechanism and amusement scene and determines the amusement means based on received amusement scene, determines the trigger mechanism based on received trigger mechanism and triggers an amusement means to perform an amusement scene.

### FIELD OF INVENTION

The present invention relates to amusement systems, vehicles and methods specifically adapted to be performed contextually on an amusement path.

### BACKGROUND OF THE INVENTION

The annual Halloween spending in the United States of America is up over 10 billion dollars. Every year the entertainment industry tries to find better ways to grab the American dollar and to up the competition through innovative new offerings. However, albeit all the developments in the field, it is noteworthy that one important item seems completely forgotten, that is the physical Hayride or vehicle. A hayride, also known as a hayrack ride, is a traditional American and Canadian activity consisting of a recreational ride in a wagon or cart pulled by a tractor, horses or a truck, which has been loaded with hay or straw for comfortable seating.

A hayride is so important that it can make or break an attraction. Some are very boring and usually the safest attraction is a haunt. Passengers typically sit there and ride around a farm and watch. Sometimes actors will jump on the wagon and produce some scares. But even these actors are rare today. Furthermore, they lack the excitement that may be derived from adding music, creating lighting effects or triggering specific scenes at certain locations, or based on certain conditions.

In some prior art, devices like a run-over (tube across the road that the wagon runs over), PIR sensor, or manual trigger are used to trigger a scene. A passive infrared sensor (PIR sensor) is an electronic sensor that measures infrared (IR) light radiating from objects in its field of view. These devices are connected directly to the prop controller via a wire (unable to connect the wire to a moving vehicle).

It is thus an objective of this disclosure to implement an amusement system capable of wireless scene activation via Wi-Fi or Bluetooth or any such, to implement an amusement scene.

### SUMMARY OF THE INVENTION

The following summary is an explanation of some of the general inventive steps for the system, method, architecture and tools in the description. This summary is not an extensive overview of the invention and does not intend to limit the scope beyond what is described and claimed as a summary.

In summary, the present invention, in some embodiments thereof, relates to system, vehicle and method for providing an amusement activity. According to one embodiment, it is provided an amusement vehicle adapted for carrying a passenger, the vehicle comprising of a wireless signal receiver, a trigger mechanism and amusement means, a wireless signal transmitter such as a beacon capable of transmitting a signal to said amusement vehicle, the signal defining a trigger mechanism, an amusement scene and a proximity context.

According to one embodiment, the wireless signal transmitter beacon transmits a signal to a vehicle in an amusement path, the vehicle receives the signal comprising a trigger mechanism and amusement scene and determines the amusement means based on received amusement scene, determines the trigger mechanism based on received trigger mechanism and triggers an amusement means to perform an amusement scene.

In an embodiment of the present invention, an amusement means may comprise a lighting effect designed to scare or amuse, such as by using frightening color patterns or amusing color patterns.

In an embodiment of the present invention, an amusement means may comprise a vibration induced on the vehicle by an industrial vibrator.

In an embodiment of the present invention, an amusement means may comprise a musical note, a sound, a scream, a horn or any such voices that may cause excitement or scare a passenger.

In an embodiment of the present invention, an amusement scene may comprise a combination of features such as lighting effects, vibration and sounds.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

However, for a more complete understanding of the above listed features and advantages of the system, methods and computer program products, reference should be made to the detailed description and the drawings. Further, additional features and advantages of the invention are described in, and will be apparent from, the detailed description of the preferred embodiments.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates an exemplary embodiment of an amusement system comprising a plurality of beacon transmitters along an amusement path.

FIG. 2 illustrates a controller in the vehicle to control and trigger an amusement scene.

FIG. 3 illustrates a transmitter means disposed along an amusement path to transmit a signal to an amusement vehicle.

FIG. 4 illustrates an exemplary method of activation of an amusement in an amusement vehicle.

### DETAILED DESCRIPTION OF THE PREFERRED EMBODIMENTS

Hereinafter, some embodiments considered most apparent in the understanding of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

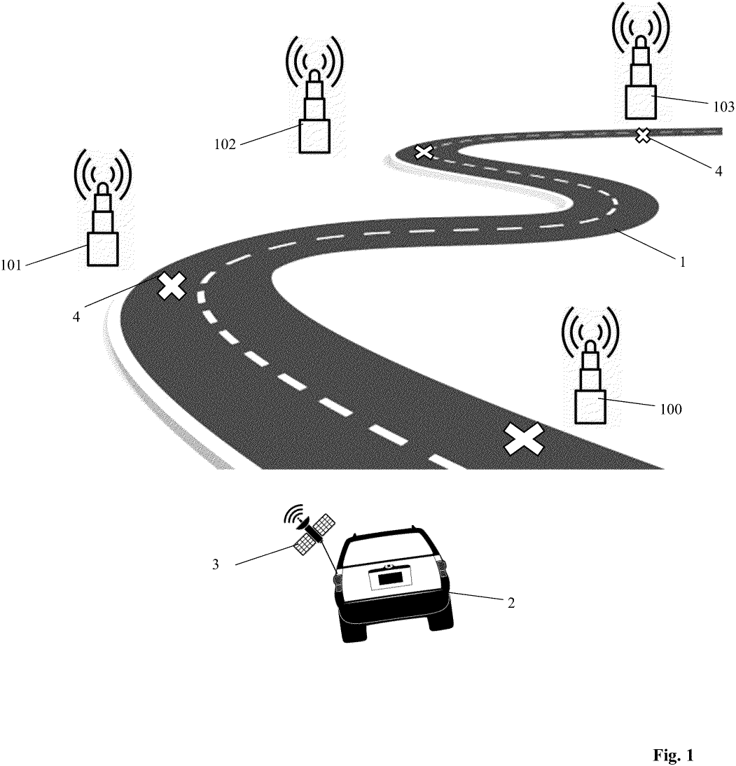

Referring to FIG. 1, illustrating an exemplary embodiment of an amusement system comprising a plurality of beacon transmitters along an amusement path. On the figure, it is shown an amusement path 1, which may include any such motorable infrastructure such as a road, or a pathway in an amusement park, a park or highway. Along the route of the shown amusement path 1, there is a plurality of transmitter beacons including 100, 101, 102 and 103, where a hayride vehicle or such will pass when along the amusement path, the points close to the beacons being identifiable as transmission points 4.

A receiver 3 is shown in the figure, along with a vehicle 2, wherein the the receiver is capable of receiving a transmission from either of the transmitter beacons 100, 101, 102 or 103, at respective transmission points 4.

According to one implementation, the satellite positioning system may be provided for detecting the position of the vehicle along the amusement path, and subsequently determine the proximity to a transmission point, and thus transmit a signal to the receiver 3 if the vehicle is close to a beacon.

According to another implementation, a proximity mechanism is provided whereby a signal is transmitted from a beacon to the vehicle’s receivers when the vehicle and beacon are in close proximity, for example, when a vehicle passes through a transmission point 4.

For each of the beacons, the transmitted signal will comprise an amusement scene and a trigger mechanism to activate the amusement scene. The signal will be received by the receiver 3, processed by a controller and an amusement scene activated by the vehicle to cause an amusement to the passengers of the vehicle (hayride).

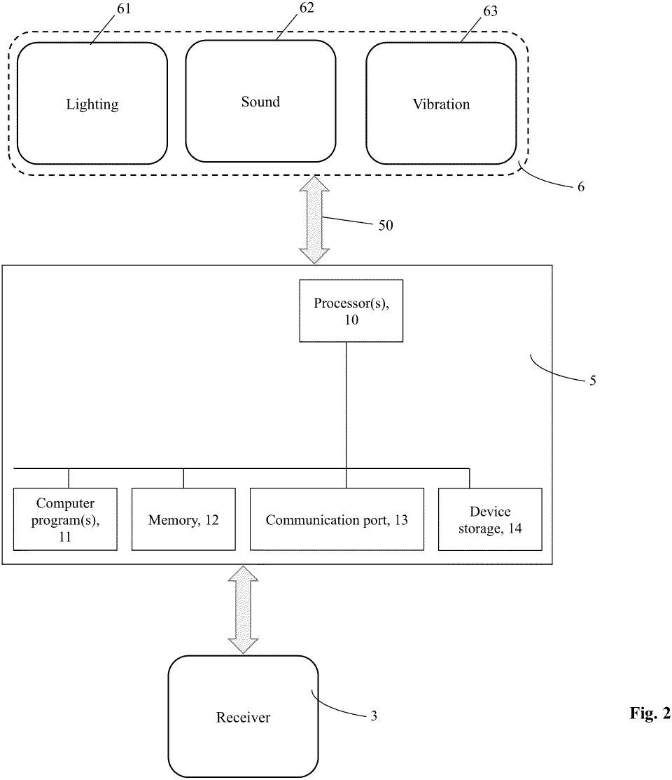

Reference is now made to FIG. 2 of the drawings, which illustrates a controller in the vehicle to control and trigger an amusement scene. The controller may comprise a portable computing device, PLC or similar. In the embodiment shown, the controller comprises a processor 10 or its equivalent, a computer program 11 comprising a sequence of instructions, configured on the memory 12, the instructions being executable by the processor. However, it is anticipated that a logic gate may also be a suitable alternative. A communication port 13 is also provided to enable communication with external devices, for example receiving the signal from the receiver 3 coupled to the controller.

Further illustrated on the same FIG. 2 is an amusement mechanism 6 comprising of a lighting effect 61, sound effect 62 and vibration 63. The activation of any one or a combination of them may be determined by the specific scene. For example, a scene may require the use of scary lighting effects and sounds, therefore requiring a combination of such effects to act out a scene. The controller received a signal comprising of the activation mechanism and amusement scene from the receiver 3, the receiver in turn receiving from a a transmission beacon. The signal is processed to determine the scene, and the activation mechanism, for example a lighting sequence, a sound pattern, the frequency, duration among others. Stored effects may also be present in the controller, stored in the device storage 14 shown on the figure.

As an example, a particular scene may entail the use of ghost sounds and vibrations. Upon the vehicle reaching the transmission point, a signal is transmitted from the beacon to the vehicle with the scene and activation mechanism. The controller upon receiving the signal activates the scene by activating an industrial vibrator to cause vibration of the hayride vehicle, and a ghost sound from among stored sounds in the storage device 14. This randomized scene creation would increase the amusement of the passengers as they cannot predict what would happen next. An activation means is illustrated as 50, indicating the activation of a sound, lighting or vibration by the controller.

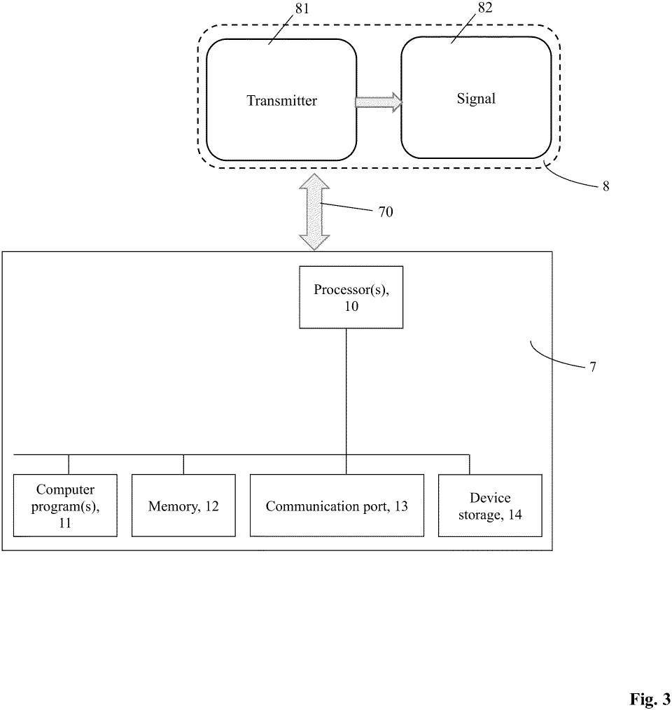

Further illustrated by the FIG. 3 of the drawings is a transmitter means disposed along an amusement path to transmit a signal to an amusement vehicle. A transmitter means may be any one of the transmitter beacons such as 100, 101, 102 or 103. A transmitter also comprises a processing means, which may be a controller comprising a portable computing device, PLC or similar. In the embodiment shown, the controller comprises a processor 10 or its equivalent, a computer program 11 comprising a sequence of instructions, configured on the memory 12, the instructions being executable by the processor. However, it is anticipated that a logic gate may also be a suitable alternative. The transmitter beacon may further comprise a proximity sensor capable of determining when a hayride is close to it. It may be configured such that it only transmits a signal to a vehicle (hayride) that is in close proximity. It is anticipated that this said proximity sensor may be a satellite-based navigation system such as GPS, GLONASS, Galileo, or any such.

Preferably, the beacon is capable of connecting to the vehicle, which acts as a server when the two are close to each other. The transmitter beacon the transmits a signal 82 using its transmitter 81. A storage device 14 may be provided to store signal information for example the amusement scene associated with that beacon, and the manner of activation such that the scene may be activated by the vehicle that receives the signal.

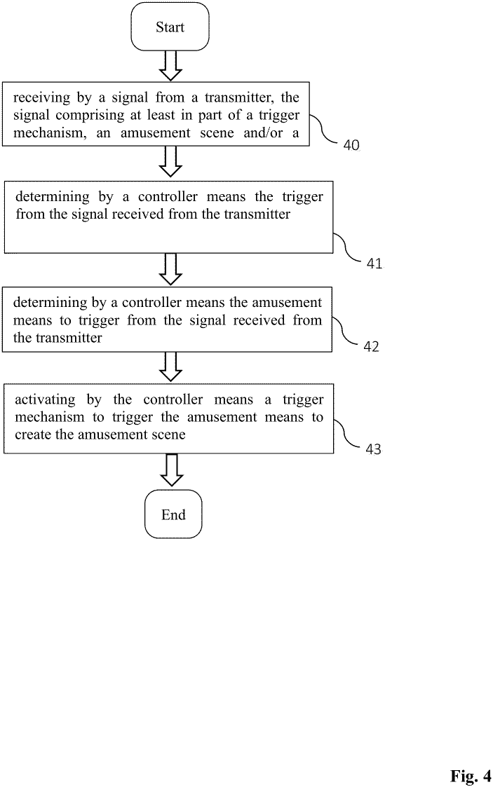

Now referring to FIG. 4, it is illustrated an exemplary method of activation of an amusement in an amusement vehicle. Starting at step 40 is the receiving by an amusement vehicle a signal from a wireless signal transmitter disposed at an amusement path, the signal comprising at least in part of a trigger mechanism, an amusement scene and/or a proximity context. Next in 41 is determining by a controller the trigger from the signal received from the transmitter. Further in 42 is determining by a controller means the amusement means to trigger from the signal received from the transmitter, and finally in 43 is the activating by the controller means a trigger mechanism to trigger the amusement means to create the amusement scene.

It is anticipated that an amusement may be a vibration, a sound and/or a lighting effect.

Further, it is anticipated that a proximity sensor may determine the transmission of a signal.

In this disclosure, the term vehicle and hayride have been used interchangeably.

The systems, apparatus and methods described in this disclosure may be used in any amusement activity such as Halloween, Christmas, Escape rooms and any such.

The controllers in this disclosure may be programmed wirelessly, and that includes the beacons and vehicle controllers.

It is anticipated that beacons may be programmed to have different beacons and sequences.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

Accordingly, the applicant intends to embrace all such alternatives, modifications, equivalents and variations that are within the spirit and scope of the disclosed subject matter. It should also be understood that references to items in the singular should be understood to include items in the plural, and vice versa, unless explicitly stated otherwise or clearly from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

### INDUSTRIAL APPLICATION

The invention is applicable in the entertainment industry, specifically in the construction and operation of amusement systems.

What is claimed is:

1. An amusement system for use in an amusement activity, the system comprising of:
an amusement vehicle adapted for carrying a passenger, and comprising of a wireless signal receiver, a trigger mechanism and amusement means; and
a wireless signal transmitter capable of transmitting a signal to said amusement vehicle, the signal defining a trigger mechanism, an amusement scene and a proximity context, wherein:
the wireless signal transmitter transmits a signal to a vehicle in an amusement path;
the vehicle receives the signal comprising a trigger mechanism and amusement scene and:
determines the amusement means based on received amusement scene;
determines the trigger mechanism based on received trigger mechanism; and
triggers an amusement means to perform an amusement scene.

2. The system of claim 1, wherein the amusement means is a vibration of the vehicle.

3. The system of claim 1, wherein the amusement means is a sound effect and/or noise from a horn, speaker or any such.

4. The system of claim 1, wherein the amusement means is a lighting effect.

5. The system of claim 1, wherein the amusement means is a combination of any of the means of claims 2, 3, and 4.

6. The system of claim 1, wherein the wireless signal transmitter comprises a proximity sensor capable of determining proximity of the vehicle before transmitting a signal.

7. The system of claim 1, wherein the wireless signal transmitter’s proximity sensor is a satellite-based navigation system such as GPS, GLONASS, Galileo, or any such.

8. The system of claim 1, wherein the wireless signal transmitter is a beacon along an amusement path.

9. The system of claim 1, wherein the amusement means is triggered conditionally depending on the proximity of a vehicle to the wireless signal transmitter.

10. A vehicle for use in an amusement activity, the vehicle comprising of:
a controller means comprising at least a processor, memory and a computer program product comprising a sequence of instructions configured on memory, which when executed control the activation of an amusement activity;
a trigger mechanism to trigger the activation of an amusement means;
a wireless signal receiver adapted to receive from a wireless transmitter, a signal comprising a trigger mechanism, and an amusement scene, wherein:
the controller means determines the trigger from the signal received from the transmitter;
the controller means determines the amusement means to trigger from the signal received from the transmitter; and
the controller means causes the trigger mechanism to trigger the amusement means to create the amusement scene.

11. The vehicle of claim 10, wherein the amusement means is a vibration of the vehicle.

12. The vehicle of claim 10, wherein the amusement means is a sound effect and/or noise from a horn, speaker or any such.

13. The vehicle of claim 10, wherein the amusement means is a lighting effect.

14. The vehicle of claim 10, wherein the amusement means is a combination of any of the means of claims 11, 12, and 13.

15. The vehicle of claim 10, wherein the signal from wireless signal transmitter comprises a proximity context, wherein the context may determine the activation of the amusement means.

16. The vehicle of claim 10, wherein the wireless signal transmitter is a beacon along an amusement path.

17. A method comprising of:
receiving by an amusement vehicle a signal from a wireless signal transmitter disposed at an amusement path, the signal comprising at least in part of a trigger mechanism, an amusement scene and/or a proximity context;
determining by a controller means the trigger from the signal received from the transmitter;
determining by a controller means the amusement means to trigger from the signal received from the transmitter; and
activating by the controller means a trigger mechanism to trigger the amusement means to create the amusement scene.

18. The method of claim 17, wherein the amusement means is one or more of a vibration, a sound and/or a lighting effect.

19. The method of claim 17, wherein the proximity context determines the activation of the amusement means.

20. The method of claim 19, wherein the proximity context is provided by one or more of a proximity sensor, and/or a satellite-based navigation system such as GPS, GLONASS, Galileo, or any such.
